(19) United States
(12) Patent Application Publication
(10) Pub. No.: US 2024/0329982 A1
(43) Pub. Date: Oct. 3, 2024

(54) Method, System and Computer Program Product for Producing High-Level Report Data from Low-Level Data Extracted from a Version Control System

(71) Applicant: minware Inc., Arlington, VA (US)

(72) Inventor: Kevin R. Borders, Arlington, VA (US)

(73) Assignee: minware Inc., Arlington, VA (US)

(21) Appl. No.: 18/415,924

(22) Filed: Jan. 18, 2024

Related U.S. Application Data
(60) Provisional application No. 63/493,342, filed on Mar. 31, 2023.

(51) Int. Cl. G06F 8/73; G06F 8/71

(52) U.S. Cl. CPC G06F 8/73; G06F 8/71

(57) ABSTRACT

Method, system and computer program product for producing high-level report data from low-level data extracted from a version control system are provided. The method includes receiving sets of commit source data extracted from a repository of one or more software objects in the version control system. Each set of commit source data includes commit patches. The commit patches are processed to obtain hunk records. The hunk records are processed utilizing a commit-blame procedure to produce output records indicating history and original source of changes from the commit patches. The commit-blame procedure is performed on input commits and commit patches to produce intermediate data records. The intermediate data records are analyzed to obtain information relating to whether software code is still surviving in a software code base or when the software code was removed from the software code base. At least one report is produced by aggregating the information.

### CROSS-REFERENCE TO RELATED APPLICATIONS

This application claims the benefit of U.S. provisional application Ser. No. 63/493,342 filed Mar. 31, 2023, the disclosure of which is hereby incorporated in its entirety by reference herein.

### TECHNICAL FIELD

At least one embodiment of the present invention generally relates to a method, system and computer program product for producing high-level report data from low-level data extracted from a version control system such as a software version control system.

### BACKGROUND

Traditionally, certain types of software development expenses are recorded as capital expenditures based on the type of work and the project, such as not including bugs or projects that produce software to be sold to customers. These capital expenditures are accrued in an asset account on the balance sheet, and then released according to a depreciation schedule.

The problem with traditional software capitalization approaches, however, is that they don't factor in granular information about how long software actually survives in a code base. If code is deleted right away, then the asset account for the software should really be decreased at that point and an expense should be recorded, just as if a physical asset like a machine in a factory was discarded. Conversely, if code continues to survive in a code base and provide value, then traditional approaches may prematurely recognize the expense of creating it and decrease the asset value before its true end of life.

### SUMMARY

An object of at least one embodiment of the invention is to provide a method, a system and a computer program product which at least partially solve the above-noted problem and other problems associated with the prior art.

In carrying out the above object and other objects of at least one embodiment of the present invention, a method of producing high-level report data from low-level data extracted from a repository of one or more software objects in a software version control system which tracks changes to the one or more software objects over time is provided. The method includes receiving sets of commit source data extracted from the repository of the one or more software objects in the software version control system. Each set of commit source data includes commit patches which describe how to modify the one or more software objects to arrive at a new state of the one or more software objects. The commit patches are processed to obtain hunk records and a list of any renamed, deleted or created software objects. The hunk records comprise records for individual segments of changed content in each commit patch. The hunk records are processed utilizing a commit-blame procedure to produce output records indicating history and original source of changes from the commit patches. The commit-blame procedure is performed on input commits and commit patches to produce intermediate data records for at least one of the input commits and software. The intermediate data records are analyzed to obtain information relating to whether software code is still surviving in a software code base or when the software code was removed from the software code base. At least one report is provided by aggregating the information.

Each set of commit source data may include commit source data may include a list of commits and a list of refs which are names or tokens associated with particular commit identifiers.

Each set of commit source data may include a set of commit source data extracted through an application data interface (API) of the software version control system.

The output records may include at least one of hunk fragment records, hunk removal records, hunk context records and blame records.

The step of performing may include planning an execution order of the commit-blame procedure on each set of commit source data that was extracted and needs processing.

The step of producing may identify attributes associated with the software code.

The method may further comprise generating a grouping of the intermediate data records into groups based on the attributes and computing aggregate values for each group to produce the high-level report data which can be used to generate reports which can be presented to a user of the reports.

The method may further comprise determining how long the software code survived in the software code base.

The method may further comprise determining amount of time it took to write the survived software code.

Further in carrying out the above object and other objects of at least one embodiment of the present invention, a system for producing high-level report data from low-level data extracted from a repository of one or more software objects in a software version control system which tracks changes to the one or more software objects time is provided. The system comprises at least one hardware processor and at least one storage device coupled to the at least one hardware processor for storing instructions that are operable, when executed by the at least hardware processor, to cause the at least one hardware processor to perform operations. The operations include receiving sets of commit source data extracted from the repository of the one or more software objects in the software version control system. Each set of commit source data includes commit patches which describe how to modify the one or more software objects to arrive at a new state of the one or more software objects. The operations also include processing the commit patches to obtain hunk records and a list of any renamed, deleted or created software objects, the hunk records comprising records for individual segments of changed content in each commit patch. The operations further include processing the hunk records utilizing a commit-blame procedure to produce output records indicating history and original source of changes from the commit patches. The operations also include performing the commit-blame procedure on input commits and commit patches to produce intermediate data records for at least one of the input commits and software. The operations further include analyzing the intermediate data records to obtain information relating to whether software code is still surviving in a software code base or when the software code was removed from the software code base. The operations also include producing at least one report by aggregating the information.

Each set of commit source data may include a list of commits and a list of refs which are names or tokens associated with particular commit identifiers.

Each set of commit source data may be extracted through an application data interface (API) of the software version control system.

The output records may include at least one of hunk fragment records, hunk removal records, hunk context records and blame records.

The performing operation may include planning an execution order of the commit-blame procedure on each set of commit source data that was extracted and needs processing.

The producing operation may include identifying attributes associated with the software code.

The operations may further include generating a grouping of the intermediate data records into groups based on the attributes and computing aggregate values for each group to produce the high-level report data which can be used to generate reports which can be presented to a user of the reports.

The operations may further include determining how long the software code survived in the software code base.

The operations may further include determining amount of time it took to write the survived software code.

Still further in carrying out the above object and other objects of at least one embodiment of the present invention, a computer readable storage medium is provided. The storage medium stores a program of instructions executable to perform operations. The operations include receiving sets of commit source data extracted from a repository of one or more software objects in a software version control system. Each set of commit source data includes commit patches which describe how to modify the one or more software objects to arrive at a new state of the one or more software objects. The operations also include processing the commit patches to obtain hunk records and a list of any renamed, deleted or created software objects. The hunk records comprise records for individual segments of changed content in each commit patch. The operations further include processing the hunk records utilizing a commit-blame procedure to produce output records indicating history and original source of changes from the commit patches. The operations include performing the commit-blame procedure on input commits and commit patches to produce intermediate data records for at least one of the input commits and software. The operations also include analyzing the intermediate data records to obtain information relating to whether software code is still surviving in a software code base or when the software code was removed from the software code base. The operations further include producing at least one report by aggregating the information.

At least one embodiment of the invention described herein is a method, system and computer program product for tracing or tracking changes to code and other content in a version control system. At least one embodiment of the invention produces reports that can show higher-level information about code/content, like the total effort put into code/content that still exists and has not been deleted, how long it survives, and how much effort has gone into code that is yet to be released to customers.

At least one embodiment of the present invention solves problems associated with the prior art by producing accurate reports based on how much effort was put into creating different pieces of code and exactly how many of those remain in the code base versus those that have been deleted. This analysis helps to assess the value of software at different points in time similar to how a traditional financial asset is valued on a balance sheet in an accounting system. By tracing what happens to code and content in a version control system, at least one embodiment of the invention can show the salary cost of new code being added to the code base, as well as the cost that went into code being removed.

At least one embodiment of the invention can further show other useful information about software, such as the amount in “inventory” that has been written but not yet released to customers, as well as the amount that is removed from inventory prior to release and the average lifetime of code post release, which can inform depreciation schedules for capitalized software development assets.

In addition to providing more accurate financial reporting associated with software development, the reports produced by at least one embodiment of the invention can help managers assess which code has different levels of quality based on what happens to them over time.

### BRIEF DESCRIPTION OF THE DRAWINGS

FIG. 1 is a block diagram flow chart illustrating various steps for implementing at least one embodiment of a method of the present invention;

FIG. 2 is a schematic block diagram illustrating conventional hardware to perform the steps of a method of at least one embodiment of the present invention;

FIG. 3 illustrates how a simple patch in diff format may be transferred into two corresponding hunk records;

FIG. 4 illustrates the relationship between commits, hunks and hunk fragments;

FIG. 5 illustrates the relationship between commits, hunks, hunk fragments and hunk removal records;

FIG. 6 illustrates three blames records (a), (b) and (c) of lengths 1, 3 and 1, respectively;

FIG. 7 illustrates a procedure for changing one line for a single parent; and

FIG. 8 illustrates two parents (i.e., a base parent (a) and a merge parent (b)) with two different blames.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

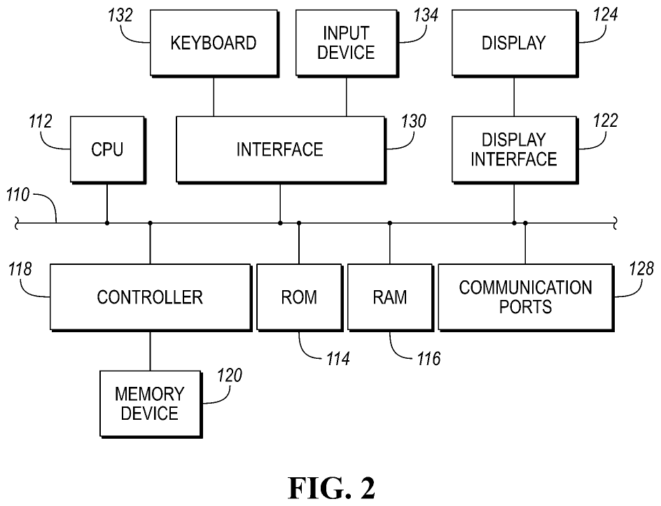

FIG. 2 depicts a block diagram of system hardware components that may be used to implement the various services and processing devices as discussed herein. A bus 110 serves as the main information highway interconnecting the other illustrated components of the hardware. A CPU 112 is a central processing unit of the system that performs calculations and logic operations required to execute one or programs. The CPU 112, alone or in conjunction with one or more of the other elements disclosed in FIG. 2, is a processing device, computing device or processor as such terms are used within this disclosure. Read only memory (ROM) 114 and random access memory (RAM) 216 constitute exemplary memory devices.

A controller 118 provides an interface between one or more optional tangible, non-transitory computer-readable memory devices 120 and the system bus 110. These memory devices 120 may include, for example, an external or internal DVD or CD ROM drive, a hard drive, flash memory, a USB drive or the like. As indicated previously, these various drives and controllers are optional devices. Additionally, the memory devices 120 may be configured to include individual files for storing any software modules or instructions, auxiliary data, common files for storing groups of results or auxiliary, or one or more databased for storing the result information, auxiliary data, and related information as discussed above.

Program instructions, software or interactive modules for performing any of the methods and systems as discussed herein may be stored in the ROM 114 and/or the RAM 116. Optionally, the program instructions may be stored on a tangible computer readable medium such as a compact disk, a digital disk, flash memory, a memory card, a USB drive, an optical disc storage medium, such as a Blu-Ray™ disc, and/or other recording medium.

An optional display interface 122 may permit information from the bus 110 to be displayed on a display 124 in audio, visual, graphic or alphanumeric format. Communication with external devices may occur using various communication ports 128. An exemplary communication port 128 may be attached to a communication network, such as the Internet or a local area network.

The hardware may also include an interface 130 which allows for receipt of data from input devices such as a keyboard 132 or other input device 134 such as a mouse, a joystick, a touch screen, a remote control, a pointing device, a video input device and/or an audio input device.

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

### I. Source Data

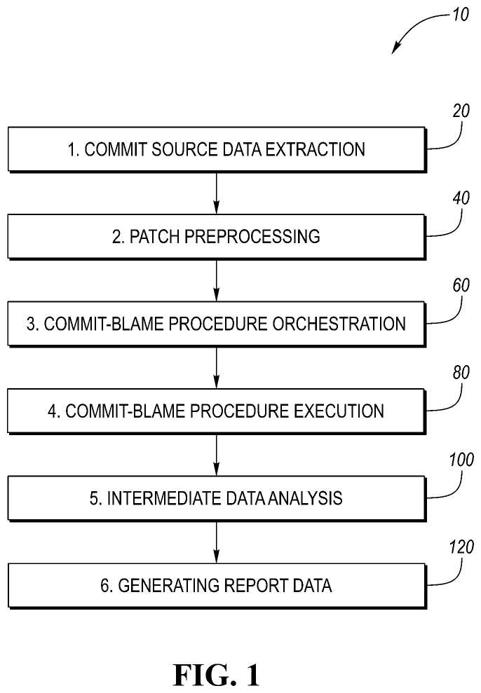

The first step in the method, system, and computer program for tracing changes is to extract data (i.e., block 20 of FIG. 1) from a version control or change history system.

There are many types of version control and change history systems, hereinafter all referred to as version control systems. A version control system is defined as a system that tracks changes to a repository of one or more objects over time. Different version control systems use different terminology, such as a change, change set, or commit. The term “commit” is used here, which is popular in version control systems for source code like Git, though the term is interchangeable with anything indicating one or more changes at a point in time.

### A. Commits

Each commit in a version control system typically contains the following properties to maintain version control semantics, though the properties may have different names in different systems:
ID—A unique identifier for the commit, such as a hash value
Patch—A representation of the difference between objects in the repository at the base parent commit and objects in the repository after this commit is applied.
Base Parent ID—The identifier of the parent off of which this commit's patch is based, which can be empty if this is an initial commit without a parent.
Head Parent IDs—If this commit is not a merge, then this list will be empty. If it is a merge commit, then this list will contain IDs of one or more parent commits that this commit is merging onto the base parent with its patch.

Commits may contain other optional metadata that is not strictly necessary to maintain the semantics of the version control system, but which is commonly included, such as:
Timestamp—The time at which the commit was made
Author—Information such as name, email address, or user identifier of the commit's author
Message—Description of changes in the commit, which may also include structured or unstructured references to IDs of other commits, particularly if this commit is a “rebase” commit that copies changes from other commits without explicitly listing them in the list of head parent IDs

### B. Refs

In addition to a list of commits, a repository in a version control system may have a list of “refs”, which are names or tokens associated with particular commit identifiers. These refs are often used to indicate which commits are at the head of named branches, such as a “main” or “master” branch for the repository, or to indicate commits associated with particular versions or “branches” of the repository for different customers, projects, or workflow stages like “staging” or “qa”. Finally, version control repositories will typically have a flag indicating which ref represents the main branch for the repository.

c. Extracting Data

Extracting data from a source version control repository typically involves listing all of the commits and refs through an application programming interface (API), or otherwise transferring these lists, such as may be contained in one or more data files. APIs for some version control systems may require separately requesting lists of commits for each ref.

Some version control systems also contain supplementary information about commits that is not contained in the records for refs or commits. This may occur if certain commits are “squash” or “rebase” commits that are effectively merging parent commits that are not contained in the list of head parent IDs in commits themselves. It may be beneficial to extract these supplemental “shadow” head parent IDs if they are present in the version control system and include them in a list of additional head parent IDs.

In addition to extracting squash and rebase commit links from other fields or objects in the source version control system, this data extraction step may perform parsing on commit messages to extract additional head parent IDs associated with rebase or squash commits depending on the semantics of how commit messages are typically constructed for the given version control system. Any additional parents that are discovered this way may be added to the list of head parent IDs.

### D. Patch Format

The patch field in each commit describes how to modify objects in the repository to arrive at a new state. There are many different possible formats of patches for different types of version control systems and repositories, but changes can typically be expressed as:
A list of zero or more removals, each removal consisting of:
   Object ID—An identifier of an object in the repository being modified, such as a file name. Optional and may be omitted if there is just a single object.
   Position—The position to start removing data from an object
   Length—The amount of data to remove from the object at the position
A list of zero or more object renames, each consisting of:
   Old Object ID—The previous identifier of the object.
   New Object ID—The new identifier of the object
A list of zero or more object deletions, each consisting of:
   Deleted Object ID—The identifier of the object being deleted.
A list of zero or more object creations, each consisting of:
   Added Object ID—The identifier of the object being added.
A list of zero or more additions, each addition consisting of:
   Object ID—An identifier of an object in the repository being modified, such as a file name. Optional and may be omitted if there is just a single object.
   Position—The position to start adding data to an object
   Content—The new data content to insert into the object starting at the position

This list is not meant to be limiting and there may also be other types of changes such as updates to object metadata, but at least one embodiment of the invention does not rely on other change types in patches.

There are a few things to note about this method of representing patches. First, some embodiments of patch representation may contain higher-level semantics than just removals and additions, such as copying data from one place to another, reformatting, or altering existing data in a way that preserves some information from that data.

While these higher-level operations may be useful in tracing the intent behind the modification, any change operation can be instead represented by zero or more removals followed by zero or more additions to achieve the same end result. As such, any embodiment that contains patches with other operations can be transformed into a patch having only removals and additions.

The presence of object creations and object additions may not be necessary in all types of version control systems, but is provided in the case where it's possible to have an empty object to disambiguate between the scenario of deleting all the content in an object and leaving it empty versus removing the object from the repository entirely.

Some version control systems might only apply to a single object (such as the change history on a single file), and as such will not have any object IDs, or object creations, deletions, or renames.

Object renames are not strictly necessary and could further be replaced with object deletions and object creations having the same data content, but they are provided for convenience.

At least one embodiment of the invention supports patches with removals and additions in any format having a position, length, and content, including patches to binary files or files with complex structure where the position may be an object or array with multiple elements. For the purposes of illustration going forward, patches are discussed that use the Linux diff format (diff for short), which is the main format used by the popular Git version control system for representing patches to text files at the granularity of file lines, and has special provisions for dealing with discrepancies in line ending sequences used in different systems. However, at least one embodiment of the invention need not rely on this format and is compatible with all patch formats, so the use of the word “diff” is intended to refer to any type of patch.

Similarly, object identifiers could be any sort of token, but file names are discussed in particular going forward because the popular Git version control system uses file names (including directory paths) to identify objects in its repositories. The term file name is meant to be interchangeable with any type of object identifier.

### II. Preprocessing Patches

The next step (i.e., block 40 of FIG. 1) in the method of at least one embodiment of the invention after extracting source data is to perform pre-processing to translate source data into a structured form. In particular, this preprocessing step involves processing patches to produce records for individual segments of changed content in each patch, which are referred to as hunks, as well as a list of any renamed, deleted, or created objects.

Different embodiments may use different schemes for creating identifiers for each hunk, but one approach is to reference the commit, the file (or object identifier) being changed in the patch, and the index of the removal or addition in the list of removals or additions for that file. So, if file xyz in commit abc has two removals followed by one later addition in a patch (for example, sorted by position), then the identifiers of those patch hunks could be abc-xyz-1, abc-xyz-2, and abc-xyz-3.

There are different ways to represent hunk records and at least one embodiment of the invention can function with different implementations, but some embodiments could use the following schema to represent hunk records:
Hunk ID—Unique identifier as described above.
Commit ID—Identifier of the commit that this hunk comes from
Object ID—Identifier of the object in the patch that this hunk comes from
Hunk Type—Addition or removal
Position—Copied from original removal.
Length—Length of addition or removal, may be omitted and inferred from content for additions
Content—The content added. May optionally include content removed for removals, but it is not necessary to include that information in this record.

In other embodiments of this method, both a removal and an addition may be specified in a single hunk record, which does not materially change the operation of the method because it is easy to translate back and forth between a combined hunk record and multiple separate hunk records (the latter by merging removals and additions having the same position).

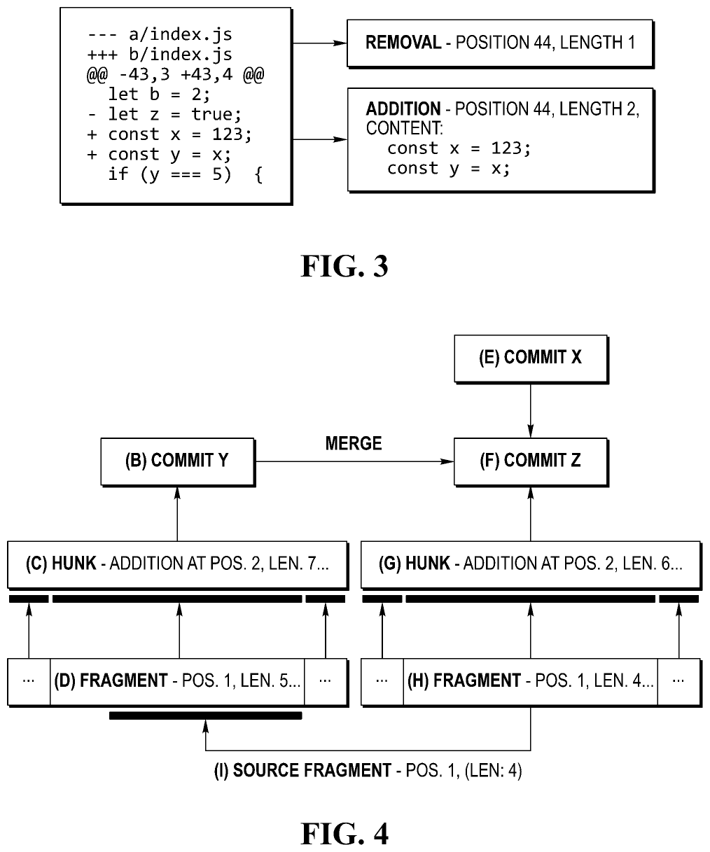

FIG. 3 illustrates how a simple patch in diff format may be transformed into two corresponding hunk records-one removal followed by one addition. In the patch on the left side, the first two lines indicate the file name before and after the change (which is unchanged in this case). The third line indicates the starting position of the subsequent lines being removed and being added, as well as the length of the segment prior to removal (3) and after the addition (4). Finally, lines starting with a space are unchanged while lines beginning with “−” are removed and “+” are added by the diff.

In addition to content changes, this preprocessing step will output a list of objects that have been deleted, created, or renamed as part of a patch. This object name change list may have the following properties:
Object Change ID—An optional identifier for this object change record, can be generated by appending the old and new object IDs to the commit ID.
Commit ID—Identifier of the commit that this hunk comes from
Old Object ID—May be empty for newly created objects
New Object ID—May be null for deleted objects

### III. Commit-Blame Procedure Output Schema

The section describes the schema (i.e. block 60 of FIG. 1) for outputs of the core method of the first stage of this invention. This method is referred to as the Commit-Blame procedure. It will produce output indicating the history and original source of changes from commit patches.

In particular, this method will indicate for each line (or other location for non-text files) in each change whether the current commit is the first time that line change occurred, or whether the source of that line change was an earlier commit. This method can further output information about the original provenance of lines being removed, as well as about lines that were in the context preceding or following the location of each change. Finally, the method can output information about the provenance of all lines that currently exist in each object in a repository as of a particular commit, also known as a “blame.”

This section describes the schema of the Commit-Blame procedure's output records and the meaning of each one in more detail.

### A. Hunk Fragment Record Output

One component of this method's output is a list of hunk fragment records. Hunk fragment records refer to sub-segments of hunk records and augment them with information about the provenance of those sub-segments. A hunk fragment record is as follows:
Hunk Fragment ID—The unique identifier of this hunk fragment record. Can be created by appending the Fragment Position as described below to the Original Hunk ID.
Original Hunk ID—The identifier of the original hunk this hunk fragment is referring to.
Fragment Position—A new position referring to the start of the fragment referenced by this record. The position is indexed from the beginning of the original hunk, not the beginning of the file. So, if using 0-based indexing, a hunk fragment covering an entire original hunk would have a fragment position of 0. As another example, if an original hunk removed 5 lines starting at line 10 in its file, a hunk fragment referencing lines 3-5 of the removal would have a Fragment Position of 2 (and Fragment of 3).
Fragment Length—The size of this fragment. The fragment position plus fragment length should not exceed the original hunk's length.
Source Fragment ID—May be empty, or may contain a reference to another hunk fragment from which the added or removed lines in this hunk fragment were copied.
Source Fragment Position—Will be empty if the source hunk fragment ID is empty. Otherwise, indicates where this hunk fragment (which may be shorter) begins within the source hunk fragment. For example, if using 0-based indexing, then 0 means that this hunk fragment was taken from the beginning of the source annotated hunk.
(The length of the fragment taken copied from the source hunk fragment is omitted here because it will be the same as Fragment Length.)
(Optionally, the fragment may copy the subset of content it references, but it does not need to do that since that content can be obtained by looking up the content on the original hunk record at the given fragment position and length, so doing this would only be for convenience or performance optimization.)

A hunk fragment record can refer to an entire original hunk, or there may be multiple fragment records referencing different fragments of the original hunk. If those fragments don't fully cover each original hunk, it would be straightforward to perform a step of filling in those missing fragments with new fragments having an empty source fragment. For the purposes of discussion, it is hereafter assumed that the hunk fragment records output by this method fully cover each original hunk with no gaps or overlapping, though this need not be the case in all embodiments of the invention.

Another embodiment of this method would be to omit the fragment length and source fragment position, assuming they are always 1 and 0, respectively. This implementation would create a separate hunk fragment for every line of the original hunks. This approach would lead to the same result as the methods described here, but would be much slower because it would require processing more hunk fragment records. So, the inclusion of fragment length and source fragment position serves as a performance optimization and not essential to the correct functioning of at least one embodiment of the invention.

### B. Hunk Fragment Illustration and Merge Example

FIG. 4 illustrates the relationship between commits, hunks, and hunk fragments. All commit patches are composed of zero or hunks, as shown by the example hunks at (c) and (g) that are part of commits at (b) and (f), respectively. Each hunk will have one or more fragment referencing segments of the hunk, each having a position and length. For example, in FIG. 4, fragment (d) references positions 2-6 of hunk (c).

When there is a merge commit, as shown at (f) for Commit Z, that commit contains its own patch to apply the results of the merge on top of the base parent commit, shown at (e) as Commit X. The merge commit will have one or more hunks in its patch, as shown at (g). However, the merge commit itself is not the original source of these changes; it is merely merging changes from an earlier head commit, shown at (b) in this case.

Furthermore, a fragment in a merge commit may not contain all the changes that were present in the head commit being merged due to conflicts. In FIG. 4, one can see that fragment (h) has a length of 4, while fragment (d) has a length of 5. The source fragment ID reference and position from (h) to (d) indicates that the changes in (h) were originally made in (d), but only a subset of changes from (d) starting from the second item in (d) are included in (h). This can occur if there is a conflict during the merge process and the merge commit omits some of the changes in the head parent to resolve the conflict.

It is not shown in FIG. 4, but also note that fragments may form a chain with multiple links via source fragment references. A fragment having a source fragment reference implies that it has been copied from somewhere else, while a fragment with an empty source fragment reference indicates that its change (addition or removal) was originally made by the author of the current commit. Merge commits often will have no fragments without source fragment references, but may have them if new changes that weren't in any parent commit were made in the merge commit to resolve conflicts.

### C. Hunk Removal Record Output

In addition to outputting information about the provenance of hunk fragments themselves, the method can further output information about the provenance of content being removed by each removal hunk fragment. The goal of doing this is to be able to later determine if and when content is removed by later commits.

Different embodiments can represent hunk removal records in different ways, such as basing them off of either the original hunk record or off of the fragment. At least one embodiment of the invention does not depend on a particular representation, but one possible schema for hunk removal records is the following:
Hunk Removal ID—Unique identifier of this hunk removal record. Can be created by appending the Removal Position described below to the Removal Fragment ID.
Removal Fragment ID—A reference to the hunk fragment making the removal.
Removal Position—Index within the removal hunk fragment that this removal record is referring to. If using 0-based indexing, 0 would be the start of the fragment.
Removal Length—Length of the segment from the removal hunk fragment being covered by this removal record. Removal Position+Removal Length should be <=Fragment Length in the referenced removal fragment.
Original Addition Fragment ID—Unique identifier of the hunk fragment record that added the lines that are being removed here.
Original Addition Position—Starting index within the original addition fragment of the content being removed.
(Original addition length is not specified here because it should be the same as removal length).

### D. Hunk Removal Illustration and Example

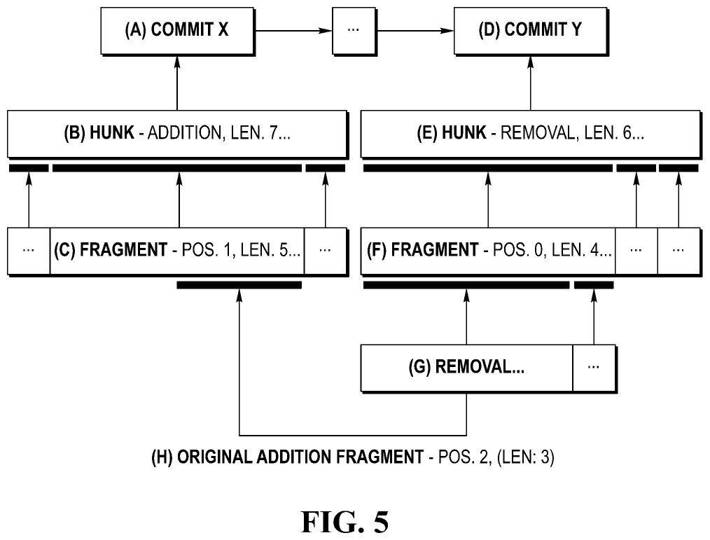

FIG. 5 illustrates the relationships between commits, hunks, hunk fragments, and hunk removal records. Similar to FIG. 4, commits may have zero or more hunks representing additions and removals. Each hunk is divided into fragments as described earlier.

Hunk removal records provide a link between removal fragments and the original addition fragments that added the content being removed. Each fragment for a removal may have one or more hunk removal records depending on whether that fragment is removing content that was originally added from multiple sources.

One can see in FIG. 5 that removal record (g) covering a sub-segment of removal fragment (f) from hunk (e) and commit (d) points to the original addition fragment (c) from hunk (b) and commit (a) that added the content being removed.

Note that the commit (a) with the original addition hunk fragment referenced in the hunk removal record may be any earlier commit in the parent history of the removal's commit (d), and does not need to be an immediate parent.

### E. Hunk Context Records

Another type of record that some embodiments of this method may decide to output, but which is not required for at least one embodiment of the invention to function, is a hunk context record indicating the provenance of lines surrounding a given hunk record before and after that hunk record's change. A hunk context record is similar to a removal record, and may contain the following fields:
Hunk Context ID—A unique ID for this entry—can be formed by appending the context offset to the Change Fragment ID
Change Fragment ID—A reference to a hunk fragment record that describes a change (either an addition or removal).
Context Offset—An offset from the base of the change indicating the line that this hunk context record is referring to. If using 0-based indexing, 0 may indicate the unchanged line immediately following the hunk fragment, 1 the line after that, −1 indicating the unchanged line immediately preceding the start of the change, −2 the line before that, etc.
Original Addition Fragment ID—Unique identifier of the fragment that originally added the line found at the provided offset.
Original Addition Position—Starting index within the original addition fragment of the unmodified lines surrounding the change.

### F. Blame Records

Finally, it may be desirable for the method described here to output a list of hunk segments from hunk fragments covering the entire content of one or more objects as of each commit. This list then effectively shows when each line in a file was originally added. This is referred to as a “blame” list consisting of blame records. It is not strictly necessary to emit this blame list as an external output of the method, and some embodiments of this method may not output blame records at all. However, blame records are an important part of how the method operates internally.

The contents of a blame record are the following:
Commit ID—The ID of the commit to which this blame record applies
Object ID—The ID of the object (e.g., a file) for this blame record.
Blame Position—The starting position of the blame record within the object (e.g., the line number)
Blame Length—The length of this blame record (e.g., the number of lines)
Source Fragment ID—The identifier of the hunk fragment that added the content in this blame record (which may in turn point to another source fragment if it was a merge, and so on).
Source Position—The position of the content associated with this blame record within the original source fragment, relative to the start of that source fragment.
(Source length is omitted since it will be the same as blame length.)
(The actual content of the object is omitted here as well, but could be copied for convenience by following the reference to the source fragment.)

Each object (e . . . g, a file) for each commit may have a list of blame records, and that list should fully cover the object without any gaps or overlapping. The sum of lengths of blame records for a particular commit/object will be equal to the size of that object, such as the total number of lines.

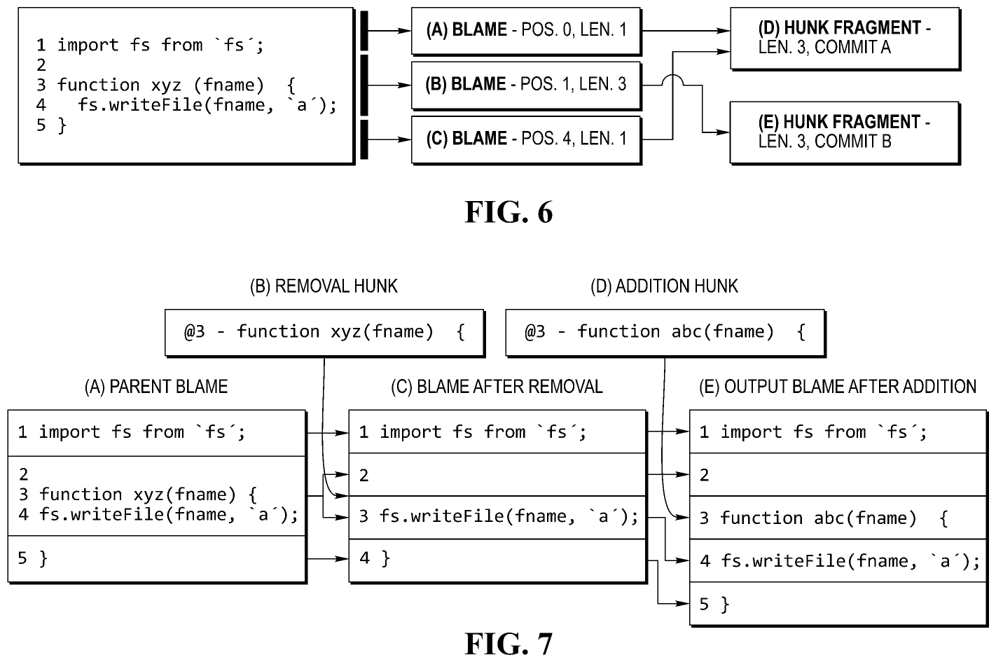

In this simple example shown in FIG. 6, there are three blame records (a), (b) and (c) of length 1, 3, and 1, respectively, which point to two original hunk fragments (d) and (e) that added the lines that currently exist in the file. This indicates that lines 2-4 were modified in commit B (which in FIG. 6 happened after commit A), while the first and last lines in the file were added in commit A, with one line from hunk fragment (d) of commit A that is no longer in the file (since its length is 3 and only two blame records of length 1 reference it).

### IV. Commit-Blame Procedure Implementation

This section describes a procedure for computing the outputs with the schemas listed in the previous section for a particular commit and object. This procedure is referred to as Commit-Blame.

This section does not discuss how to execute the Commit-Blame procedure across multiple files and commits, which is covered later.

### A. Inputs and Outputs

The Commit-Blame procedure takes the following inputs:
Commit ID—The ID of the commit for which this sub-procedure should compute blame records.
Object ID—The ID of the object for which the blame is being computed. If the object is renamed as part of the commit, this should be the new object ID after the rename.
Hunks—List of all hunk records associated with this commit and object.
Parent Blames—A list of zero or more blame record lists (each having zero or more blame records of their own) for parents of this commit for the same object obtained by running this function, with the first parent blame being considered the “base”, and any additional parent blames treated as commits that are being merged into the base via this commit.
Parent Removal Lists—A list of zero or more removal fragment lists (each having zero or more removal fragments of their own) for parents of this commit for the same object obtained by running this function, with the first parent removal list being considered the “base”, and any additional parent removal lists treated as commits that are being merged into the base via this commit.

Note here that Commit-Blame expects to receive the parent blames and parent removal lists inputs from the outputs of executing itself on each of its parent commits. If run on a commit without a parent, the parent blames and parent removal lists arguments will be empty.

The Commit-Blame procedure may generate the following outputs. Only the blame records and removal list outputs are required to feed into other calls to Commit-Blame as inputs, and the other output fields are optional.
Blame Records—List of blame records representing the blame list for this commit/object.
Removal List—A list of all removal hunk fragment records for this commit/object as well as all parent commits/objects objects along the base parent path (i.e., taken from just the first parent removal list in each invocation of this method)
Hunk Fragment Records—List of all hunk fragments associated with the provided input hunks
Hunk Removal Records—List of hunk removal records associated with removal hunk fragment records.
Hunk Context Records—List of hunk context records associated with hunk fragment records.

### B. Single Parent Scenario

In the simple case where a commit only has one parent, the way that the Commit-Blame procedure works is as follows. Note that these steps are described in a certain order, but they may be reordered without impacting the functionality of the procedure.

First, it processes all of the input hunks, creating a hunk fragment for each one that fully covers the input hunk. Because there is only one commit parent, changes represented by the input hunks are not coming from a merge parent, so their source fragment references will be empty in this scenario (later it is discussed how the source reference may be set if there is a copy).

Next, Commit-Blame processes removal hunks to generate hunk removal and hunk context records. For each removal hunk, the procedure looks at the blame records residing in the span of lines that are being removed to create hunk removal records. These removal records should cover the length of the current removal fragment. They may reference one or more addition fragments from the blame list. Commit-Blame may then create hunk context records for the removal fragment that reference one or more lines before or after the removed lines in the blame list.

The procedure may then produce an intermediate output blame list with removals applied by updating the input blame list from the parent commit to cut out lines corresponding to each removal hunk. This may involve deleting blame records entirely, or partially truncating them at the start or end by reducing their length and updating their blame position and source positions accordingly to no longer reference the removed lines. If there is no parent, then the intermediate output blame list will just be empty.

The procedure may then process the addition hunks to generate context records following the same approach as with removal hunks to create context records pointing to the blame records covering lines before and after each addition.

The procedure will then update the intermediate output blame list that has already had removals applied by inserting a new blame record for each addition hunk at the appropriate position, splitting existing blame records and updating lengths/positions accordingly if the addition hunk falls in the middle of a blame record. If there is no parent, then the blame records will consist solely of addition fragments for this commit and object.

Finally, the procedure should also append any hunk fragments that are removals to the parent removal list of the parent to produce a new appended removal list.

The procedure will then output the updated blame record and removal list along with hunk fragment, hunk removal, and hunk context records that it generated.

FIG. 7 illustrates how this procedure operates in a simple scenario where one line is changed for a single parent. The parent blame (a) contains five lines with a function named “xyz” declared on line 3. The input hunks remove this line in (b) and replace it in (d) with a new function named “abc”. The intermediate state of the blame after applying the removal is shown in (c), with the middle blame record originally spanning lines 2-4 in the input blame split up into two records each of length 1. Finally, the addition hunk is applied to insert a new blame record between the split blame records on line 3.

The hunk removal and hunk context records are not shown here, but the removal record would reference the middle line 3 of the fragment referenced by the blame record, while before/after context records would reference the addition fragments referenced by lines 2 and 4 from the middle blame record.

### C. Multi-Parent Scenario

The scenario with multiple parents is more complicated than the single-parent scenario. In this case, the first parent in the list of parents is the base parent off of which the input hunks make their changes. The Commit-Blame procedure will still output hunk fragments covering each of the hunks, but there may be multiple fragments for one or more hunks, and they may have source fragment references set to hunks coming from the additional merge parent blames.

### 1. Linking Additions in Multi-Parent Scenario

To properly link addition fragments to fragments from a merge parent, the method use the following approach. The first step is to first compute the new blame list as described in the single parent scenario. Then, the procedure can compute the difference between the file content in the output blame list (after applying the changes for this commit/object) with the blame list for each merge parent. For each segment of lines in the output blame list that are newly added by addition fragments for this commit/object and also exist in the merge parent blame list (i.e., it is not changed in the computed difference), the method may add source fragment references to those new addition fragments that point to addition fragments from the merge parent blame, splitting the new addition fragments as necessary if they align with multiple addition fragments in the merge parent blame so that each new output fragment references one source fragment. Then, the only remaining new fragments that have no source reference will be those made in the commit itself and not present in any of the parents.

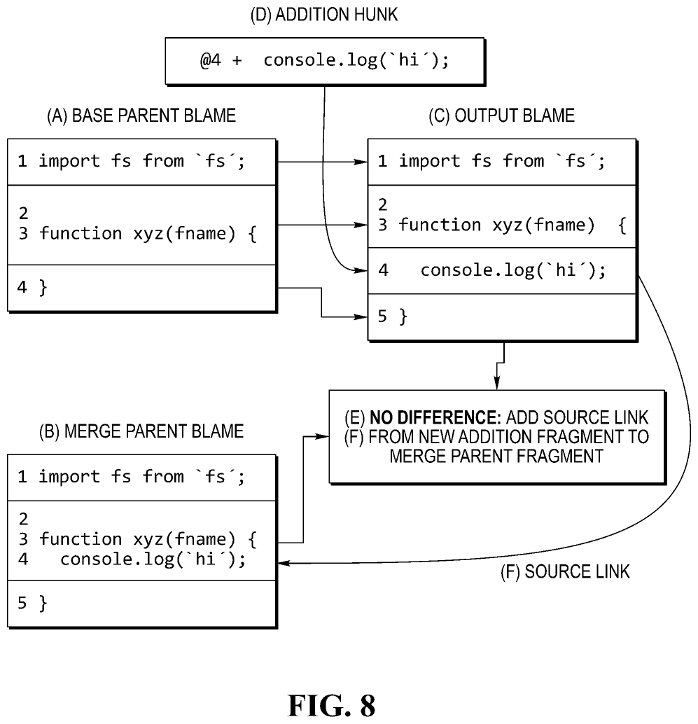

FIG. 8 illustrates how this procedure works in this scenario. In FIG. 8, there are two parents with two different blames, the base parent (a) and merge parent (b). The hunk list for this merge commit consists of a single addition hunk (d). The procedure first applies this hunk to create the initial output blame (c). It then compares the difference in step (c) of the output blame (c) and the merge parent blame (b) to identify new lines that are present in both. Because the new line 4 in the output blame is the same as line 4 in the merge parent blame, the procedure will then update the source link (f) of the output fragment referenced in the output blame to point to the last line in the addition fragment referenced by the merge parent blame. FIG. 8 is simplified and does not show the full reference structure of blame lines to hunk fragments, but each section in the blame illustrations is meant to point to one addition fragment, and the source link is between the addition fragments referenced by the blame records.

### 2. Linking Removals in Multi-Parent Scenario

The approach of comparing blames does not handle linking of removal hunks to source removal hunks because those are not present in the source parent blame list.

To handle removal linking for each merge parent, the method may first extract the list of removal hunk fragment records for that merge parent up to but not including the first record contained in the base parent removal list. This represents the set of removals since the latest common ancestor.

The method may then compare the difference between the list of removals from each merge parent and the list of removal fragments being applied by the current commit. For this comparison, it may be helpful to sort both lists by position in the file at the time of removal. The comparison should look at the content removed by these respective lists and not just the positions or entire fragments, because the respective lists may have different sizes of fragments representing the same removed content.

After computing the difference, any removal fragments from the current commit that match removal fragments in the merge parent list (i.e., they are not changed in the difference) may then be linked to removal fragments from the merge parent in a similar manner to the method of linking addition fragments (splitting removal fragments that correspond with multiple removal fragments from the merge parent removal list), after which the only removal fragments not containing a source link will be lines removed by the current commit. This achieves the goal of recording provenance information for removal fragments when there are multiple parents.

D. Handling Removals with Intermediate Reverse Merges

One additional caveat occurs in the scenario where a branch B is merged into branch A, but branch A was previously merged into branch B in the reverse direction after branch B was created. In this case, a removal in branch B that occurred before the reverse merge may refer to content that was since changed in branch A and merged into branch B. The problem happens when the removal remains in the branch B (i.e., the reverse merge rejects and does not include the new content from branch A) and is later merged back into branch A. During the final merge, the combined removal list coming in from branch B will only show a removal of the old content and not of the updated content, so the removal that gets merged will fail to link to the place that the removal originally occurred in the branch and instead show up as a new change in the final merge, which can later lead to over-reporting merge conflicts.

To address this issue, the method for linking removals in the multi-parent scenario can perform an additional step of updating content in removal lists. To do this, the method can first find the most recent common ancestor along the base parent path only between the base parent and a merge parent. It can then find the most recent common ancestor across all parent paths, which will be a later common ancestor because a reverse merge is present.

The method can then restore the blame at the first base common ancestor and at the second all-parent common ancestor. A blame can be restored by removing additions and restoring removals to obtain the blame at the time of an earlier commit. Finally, the method can take the difference of these base and all-parent blames to obtain the set of changes that were reverse merge. (Note, if there is no reverse merge, then the baes and all-parent ancestors will be the same commit and there will be no difference to apply.)

Using this reverse merge patch, the method can temporarily update the content referred to by the removal hunks coming in from the merge parent prior to computing their difference as described earlier. This ensures that the removal hunks refer to the content from the more recent all-parent common ancestor rather than the original base ancestor. As a result, the comparison between the updated removal list and the removals occurring in the current commit will be able to correctly link them to the merge parent removals rather than indicating that the merge commit itself made those changes.

### E. Handling Moves, Copies, and Restores

There are many scenarios where content may be moved, copied, or restored from content previously added elsewhere in the repository. In these cases, it may be desirable to link the addition hunk fragments that are duplicated to the original addition hunk fragments that created the content being duplicated. This will make later computation of code longevity and amount of new content added more accurate because the moves, copies, and restores will no longer be treated as adding new content.

To handle copies, the Commit-Blame procedure may search through other addition hunk fragments referenced in any parent blames to find matching copied content. To identify moves, it may further search for matching addition hunk fragments in hunk removals for the current commit, indicating that the current commit moved some content by deleting it in one place and adding it in another. Finally, it may search through addition hunk fragments referenced by parent removal lists to find content that may have been deleted earlier and is being restored by the current commit.

Depending on the desired results and level of computational effort, this step of identifying moves, copies, and restores may also involve searching other files, not just hunks and removals for the current file. Doing this would require the Commit-Blame procedure to take in additional inputs for hunks, blames, and removal lists associated with different objects.

The actual method used to determine what qualifies as a copy between two different segments of content in this procedure may take any form, and there are many existing algorithms available for copy identification, including in the git version control tool itself for identifying copies. The Commit-Blame procedure does not depend on any particular method of copy identification.

Once one or more copies have been identified, the parts of the addition hunk fragments being copied can be updated to have their source fragment references point to the original addition hunk fragments. It may be desirable in this case for the procedure to include an additional field in each hunk fragment output record indicating the type of source fragment reference so that later analysis can discern between merges, copies, moves, or restores.

### V. Orchestrating Commit-Blame Execution

After data has been extracted from a source version control system and patches for each commit have been preprocessed, the next step is to execute the Commit-Blame procedure (i.e., block 80 in FIG. 1) on input commits/patches to produce output data for all input commits and objects.

This execution step first involves planning the execution order of Commit-Blame on each commit that was extracted from the source data and needs processing. It is desirable to avoid unnecessary overhead from executing Commit-Blame multiple times on the same inputs. This execution plan can be constructed by following parent links in commit records extracted from the source data, starting with the set of commits that need processing and following parent base parent and head parent links in those records back to the original parent commits that do not have a parent, scheduling the commits for execution in order so that children will execute after their parent commits have been processed.

This planning may be done in multiple ways, but one possibility is to use a recursive function with result caching (i.e., storing the result of running Commit-Blame on each commit temporarily so that when a second child of the same parent executes, it can use the stored result that was generated when the first child requested parent execution). This function can start from the commits to process and call itself on each of its commit parents to return the result of executing Commit-Blame on those commits

Once an execution plan has been created for the commit tree, the next step (which could also be performed first without affecting functionality) is to split up the input hunks by object ID. In the simple case where object IDs are never changed or removed and re-added, this would just entail grouping all hunks by object ID and commit ID. Then, the commit execution plan could just be run once for each distinct object ID, passing in the output of running Commit-Blame on parents directly to the input of running it on children having the same object ID. Between different runs, any result caching could be purged to avoid running out of memory for larger repositories.

In the case where objects are renamed, the execution method needs to account for object ID changes when connecting the outputs of parent Commit-Blame calls to the inputs of children. To handle this, the execution method should check to see if there is an entry in the object name change list for each commit. If there is, then the execution method should use the result of calling Commit-Blame with the old Object ID in the name change record. If there is a name change entry indicating that the object was newly created, then the method may either stop, or proceed to look for an entry indicating that an object with the same ID was previously deleted, so as to connect the new file creation to the history of the old file with the same name, which can be beneficial in the case where a file is deleted and later restored to link the removals and additions as a restore rather than deleting and adding new content.

### A. Parallel Execution

It may be desirable to execute Commit-Blame in parallel for repositories with large amounts of data in order to process the entire input data set more quickly. Parallelizing the workload by commit wouldn't be as effective because different commits have dependencies on each other.

A better way to parallelize the work is by object ID. The problem is that if you just distribute work to different execution nodes based on object IDs, it is possible that changes to the same file that is renamed may end up at different execution nodes, which could lead to unnecessary extra computation or the procedure failing if the data is not available.

So, if performing the execution step using parallel processing in different computer processes or computer systems, it is first beneficial to group all objects together that may be renamed from each other. This can be achieved by repeatedly traversing all object IDs that are linked by any object rename record for any commit via the link between the old name and the new name, then grouping together object IDs that were ever renamed from each other together so that they are always executed on the same processing node. Though this could theoretically limit parallel processing, in practice, large repositories tend to have large numbers of objects that are not ever renamed from each other, so this approach does a good job of handling the less common case of object renames in a correct and efficient manner.

### B. Incremental Execution

In some usage scenarios, it is desirable to incrementally execute Commit-Blame repeatedly on an ongoing basis to process new data as it is generated, rather than just run it once in a single batch on an entire repository.

To support incremental execution, the method described in this section may be performed just with the identifiers of new commits that have been added since the last execution. In this case, the method will use those provided commits as starting points for processing. If the previous blame and removal list outputs from processing earlier commits have been stored as part of an earlier execution, then those may be loaded and used as inputs when processing the new commits to avoid re-processing them. If not, the incremental execution method will have to recreate the blame and removal lists of parents to provide as inputs when running Commit-Blame on the new commits.

C. Handling Merges with Different Renames

There is an edge case in certain version control systems like git where a file rename is not actually an explicit change operation that is recorded in the version control history. Instead, it is inferred from the fact that one file is removed and another is added having substantially the same content or file name.

As a result of this, there may be situations when comparing the blames of particular files during a merge where one side of the merge shows a single blame history with a rename occurring, and the other side has two separate blame histories-one where a file was completely deleted and another where a new file was added. The current state of the objects will be the same, but these different histories can lead to improperly attributing a lot of changes to a merge commit indicating a merge conflict when this is not the case.

To address this issue, the execution method described here can look for disconnections on one side of a merge when the other contains a rename. It can then re-process those commit/object pairs on the disconnected side as if a rename record were present in that branch as well to avoid having different histories.

### VI. Intermediate Data Analysis

The next step (i.e., block 100 in FIG. 1) in the method in the method, system, and computer program for tracing changes is to analyze the output data from executing the Commit-Blame procedure to produce intermediate data records that can form the basis of later reports.

This section outlines different types of analysis that may be useful to perform on the original source data and the output data of the previous step.

### A. Integration Branches

While many repositories will explicitly designate a single main branch that is used as the basis for creating feature branches, some repositories also use long-running integration branches, such as “dev” or “qa”. It can be helpful to identify these integration branches for downstream analysis described later in this section.

One approach for doing this is to look at the number of different merge commits into branches other than the main branch to see the number of distinct merges. If that number exceeds some threshold, which could be specified statically or set dynamically based on other attributes of the repository such as the number of commits, it could be classified as an integration branch. The significance of this is that code merged into an integration branch may be considered “done” and usually is likely to merge into the main branch at some point in the future.

### B. First Main/Integration Merge

It can also be helpful to know when content is first added to a main/integration branch via a merge commit. This allows us to track how long it sits around waiting to be merged, as well as what portion of hunks were removed prior to the first merge. This can serve as an indication of the efficacy of the changes.

There are two possible approaches for analyzing the first main/integration merge. One is to trace the commits themselves. This can be done for each hunk fragment by looking at the commit that it came from in the source data. Then, starting from this original commit C, a search can be performed for the first commit D that exists on a main/integration branch and is a child of C, meaning that it merges C into the main/integration branch. (A list of all the main/integration commits can be obtained by starting from the most recent “head” commits for each of those branches identified in the previous Integration Branches analysis and iterating back through all parents along the base path following the base parent ID only.)

To optimize searching through commits and merges, it may be desirable to perform an additional pre-processing analysis step of generating records that link commits directly to merge commits that integrate them into other branches. This reduces the need to iterate through non-merge commits during the search process.

Another way to find the first main/integration merge is to follow the chain of hunk fragments themselves rather than searching the commit graph. In this approach, one can similarly perform a search for the first merge commit that merges content into a main/integration path by following the links from a starting hunk fragment F to the first hunk fragment G that comes from a commit on a main/integration branch. The fragment G can be found by progressively searching for hunks having a source fragment ID pointing to F, then pointing to the next fragment, etc. The benefit of this method over searching through commits is that it will not include hunks that were deleted before being merged.

For both of these methods, there are a few different ways to perform the search. The search may look for the closest merge in terms of proximity in the commit graph (lowest number of merges), or simply the earliest date. Whatever the method chosen, it may be desirable when searching to perform a breadth-first search where other commits or fragments are explored in order of their proximity or date such that the search procedure can stop when it finds one result because it has already explored all earlier paths.

The output of this step may be a list of the following:
Original Hunk Fragment ID (or Hunk ID, or Commit ID, which can then be linked back to hunk fragments, if using the method of tracing through the commit graph)
First Merge Commit ID—The ID of the first merge commit that merged the changes into a main or integration branch.

It may further be desirable to separately compute integration branch merges and first main branch merges, which can be used to measure how long it takes for completed changes to reach the final deployment stage.

Furthermore, it may be desirable to emit records indicating the first merge for each commit and the first merge for each hunk fragment separately. That way, you can look at hunk fragments that have not been merged, but are part of commits that have been merged, indicating they have been deleted and will likely never merge.

### C. Main Branch Code Survival

The next type of analysis that can be performed using the hunk fragment and hunk removal data involves computing how long code survives once it is merged into the main branch (or an integration branch). This can be helpful to tell how quickly code is being deleted, which could indicate quality problems, or lack of deleted code, which could indicate neglect. It can also enable computing the total amount of time spent writing the code that remains in the repository by looking at time spent on the original commits compared to how much code from those commits has been merged into the main branch and not yet deleted. Yet another application is computing how much time specifically went into particular files, not including removals.

Code survival can be computed by linking addition hunk fragments on the main branch with hunk removals that reference those addition hunk fragments. This will indicate the commit at which each line is added and at which it was partially or fully removed. One can then calculate the number of lines remaining from the original addition hunk at points in time following removals. This can be done by producing “removal link” records with the following fields:
Addition Hunk Fragment ID—ID of the hunk fragment that added some code on the main branch.
Timestamp—The time of the update
Lines Remaining—The number of lines remaining after this point in time until the next record-will be size of addition hunk fragment ID in initial commit, and decrease to 0 once the entire hunk fragment has been removed.
Hunk Removal ID-Optional, if the lines remaining is decreasing, this is a link to the hunk removal that caused the decrease.

Note that this data links removals to hunk fragments where code was originally added to the main branch, but that may have been a merge with source hunk fragment links pointing back to an original commit from a branch. To further calculate code survival based off of the original branch commit, the addition hunk fragment ID may be linked to the original addition hunk by traversing the chain of hunks through the source fragment ID field until reaching a fragment that does not have a source (i.e., it is the original place where content was added).

The challenge with linking to original source fragments is that they may be copied and merged into the main branch multiple times. So, if you just aggregate removal link records by the original source fragment for the addition hunk fragment on the main branch, you can end up with a sum of lines remaining that exceeds the number of lines in the original source fragment (if it is copied or merged multiple times in different places), leading to unexpected results.

One way to solve this problem is to compute the number of lines from the original commit that still exist in at least one place, but not double-count lines with more than one copy. This can be done by considering the positions and lengths of the addition hunk fragments on the main branch when aggregating them together as part of this analysis. For each line in the original addition fragment, the aggregation step in the analysis method can record the number of distinct addition hunk fragments from removal link records that include that line. It can then count the number of hunk removals that also include that line to produce a count with the current number of copies for each line over time. Then, the lines for an original commit addition hunk can be summed together, with lines having a count of one or more being counted only once as having at least one copy, and lines that are no longer present can be counted as zero. This can produce output records with similar fields as described above for “removal link” records. The difference is that there would be one record for each original commit addition hunk fragment ID rather than potentially multiple records—one for each merge. Also, the lines remaining would indicate the number of distinct lines remaining excluding copies, making it strictly less than or equal to the length of the original commit addition fragment. This is a more suitable number for calculating code survival metrics than a value that can double-count copies.

### D. Merge Conflict Detection

Another useful analysis step that can be performed on hunk fragment data is looking at merge conflicts. A merge conflict has no formal single definition, but is generally considered to occur when the changes being merged into a branch in a version control system modify something that has changed since the original branch was created.

For trivial merge conflicts, the user can just accept the changes that occurred in one or both branches. If this happens, then all of the addition and removal hunk fragments in the merge commit will point to source hunk fragments that came from an earlier commit.

In the scenario of a bigger conflict, someone may have to modify code and make new changes as part of the merge commit, which may lead to hunk fragments that do not have a source fragment in an earlier commit.

To measure the prevalence of merge conflicts, analysis may be performed on merge commits to produce records as follows:
Merge Commit ID—ID of the merge commit (commit having more than one commit parent)
Total Lines Added—Total of all addition hunk fragment lengths
Conflict Lines Added—Sum of addition hunk fragment lengths for addition fragments not having an original source in an earlier commit
Total Lines Removed—Total of all removal hunk fragment lengths
Conflict Lines Removed—Sum of addition hunk fragment lengths for removal fragments not having an original source in an earlier commit

### VII. Generating Report Data

The outputs from the earlier steps and the intermediate analysis procedures emit a large volume of data. To provide useful reports, it is helpful to group this data using various attributes and compute aggregate values for each group to generate higher-level information (i.e., block 120 in FIG. 1). This section describes a variety of different reports that can be generated using at least one embodiment of the invention, but this is not meant to be limiting and there may be other reports not described here that could be created from data produced in earlier steps.

### A. Attribute Grouping and Filtering

The first aspect of the report data generation step is identifying attributes to use for filtering our data or grouping it into buckets, which may then later have aggregate values computed.

The low-level data records contain information about individual commits, as well as files and line numbers. There are many different higher-level entities and attributes onto which these low-level attributes may be mapped, but here some of the most useful attributes to apply are described.

First, there are several attributes related to people that may be relevant:
Author—The person who wrote the code in the original commit
Reviewer—Any person or people who reviewed the code prior to it merging
Comitter (or Merge author)—The person who merged the code into the code base.
Remover—For code survival, the author of the commit that removed code from the main branch

Additionally, any higher-level attributes associated with people may be extracted from one or more of the individual identity fields described above, such as:
Team—Which team is the person on?
Division—Which division within the organization is the person part of?
Job Role.
Years of Experience
Salary
Performance Review Scores

Next, there are attributes that can be derived from just the commit metadata, such as:
Ticket—Any ticket linked to by the particular commit, or a pull request or branch name that includes this commit. Could also include the ticket assigned to the author most recently marked in-progress if no direct link is available.
Epic, Initiative, Ticket Type, Sprint, Project, Board or other ticket attribute—Any other attribute of ticket may be used here based on the linked ticket.
Day, week, month, year, etc.—Any attributes derived from the date.

Finally, lower-level data has information on specific code lines in particular files. There is a large number of potential attributes that may be extracted from code, but some examples include the following:
Language or file extension
Repository
Full file name.
Name of function, class, or other declaration within file
Frameworks or code patterns used in the file
Testing code coverage of file or procedure
Code quality metrics of file or procedure, such as cyclomatic complexity, overall size of file, presence of code scanning warnings, etc.
Age of file

### B. Value Computation

The data from records described earlier contains values expressed in terms of the length of content. For text files, this length may be a number of lines.

One option for computing aggregate values for this report is to just use the number of lines directly, such as showing the number of lines added and removed from a repository over time.

However, line counts are known to be an inaccurate reflection of effort because some lines take much longer than others to add, so it may be helpful to multiply the ratio of lines in a particular fragment to the total lines present in its original commit to obtain a commit ratio.

This commit ratio can be used directly to calculate the number of total commits associated with some activity. However, not all commits have the same level of effort either, so it may further be beneficial to multiply the commit ratio by some computation of effort that went into the commit, such as the number of work hours inferred from time since the last commit, or taken from a time tracking system. Finally, this could be multiplied by a salary cost to produce an estimate of actual money spent.

Another potentially useful way to compute values is to utilize density. This can be particularly helpful when displaying values for groups of different sizes, such as different files. A metric such as aggregate work days spent grouped by file may make more sense to further divide by lines in that file to obtain aggregate work days spent per line—an indication of how quickly or slowly content in a given file was written normalized for files of different sizes.

### C. Main Branch Inventory Report

The first type of report that may be generated from data records described earlier is what is referred to as the inventory report. This report can compute aggregate values related to content in a version control system at a particular point in time.

While it would be less useful to just compute the number of lines of code using at least one embodiment of this invention because that value could be derived from the version control system itself, the inventory report can produce more useful results by computing other values derived from commits that originally created those lines. For example, the inventory report can show the total number of work hours spent writing code still in the repository, or further convert those work hours to dollars using salary information. This information can be used in a number of ways, such as to see the cost of writing code that currently exists for particular files or areas of the code, or for different people or teams.

The inventory report can be produced for the main branch using the main branch code survival records described earlier, which each describe a hunk and the number of lines that currently exist in the main branch for that hunk at various times. To calculate values for the hunks active at a specific time, an analysis procedure can look at the most recent record from the main branch code survival record for original addition hunk fragment ID. It can then divide the remaining lines at that point in time by the total lines from the original commit or apply some other heuristic to compute the ratio of effort from the original commit that those lines represent. Finally, that effort ratio may be multiplied by the total effort in the original commit and aggregated to arrive at the total effort still surviving in the main branch of a repository.

### D. Inventory Aging Report

While an inventory report just shows the total amount of code present in a repository, an inventory aging report groups that code by how old it is. This can be helpful to understand how much exists of different ages.

To produce an inventory aging report, each record that represents a reporting group (such as an author, repository, type of file, etc.) can include multiple values for different age buckets rather than a single value. These buckets can be divided based on the desired granularity of the report, such as by days, months, years, or other time intervals. The values here can be in the same units as values in the inventory report, such as work time or actual salary cost.

### E. Non-Main Branch Inventory Report and Inventory Turnovers

Another useful type of report involves looking at the inventory of code that has not been merged into the main branch. This can show, for example, the number of days of work that is currently awaiting release to customers, which can indicate how fast the development process is.

Non-main branch inventory can be calculated by looking at all of the commits that are not in a main/integration branch, and which do not have any records in the first main/integration merge intermediate analysis. It may further be desirable to only count commits that are ancestors of currently active branch refs, excluding commits on branches that have been deleted.

It may also be desirable to exclude integration branches from this measurement, or group the measurements separately by each branch name. This makes it possible to see how much effort has gone into code that has made it to each step of a workflow through other branches that may exist like integration and testing. Grouping all branches separately would further make it easy to see the level of inventory associated with different projects.

Given that work in non-main branches is generally supposed to be temporary and not permanent, it may also be beneficial to exclude code that is over a certain age as presumably abandoned, based either on the age of the commit itself, the age of the commit at the head of its branch, or some other heuristic.

Once non-main branch inventory has been calculated, another value that may be computed based on the limited lifespan of this inventory is the average number of “inventory turnovers” per time period, such as per year. This inventory turnover ratio can be calculated by dividing the time period (such as a year) by the average level of inventory during that time period, expressed in terms of total work capacity, such as person-years. This metric can indicate the speed at which code moves through workflow steps on its way from development into production.

### F. Pre-Merge Code Churn Report

Another thing that can be helpful to know is how much code is being removed from non-main branch inventory during each time period and discarded rather than moving to production.

Code churn can be calculated for code on non-main branches using the records computed in the intermediate first main/integration merge analysis step. One method for doing this is to start by looking at the set of all hunk fragments for commits where the commit itself has been merged. Then, the method can compute the total size of just the specific fragments that were merged, and subtract that from the total to arrive at the number of hunk fragments that were undone or superseded prior to the merge. These values may be displayed in output records based on the time at which they were originally written, or the time of the merge.

In addition to churn caused by deleting hunk fragments prior to merging their commits, there can also be churn from commits being abandoned entirely and never merged as described in the previous section. This churn can be computed by setting a threshold of a maximum age (either of original commits or the latest commits on their branches) after which the code will be presumed abandoned.

This pre-merge code churn may be expressed in terms of lines of code, work time, or salary cost of the code created, depending on the desired application.

High amounts of pre-merge code churn can indicate a lot of different underlying problems, including unclear or changing requirements, lack of understanding about the task at hand leading to high rework, poor code quality, lack of good testing procedures, and many other issues.

Additionally, it is possible to compute churn on removal hunk fragments as well. This can be done by comparing the size and amount of removal hunk fragments that are merged compared to all removal hunk fragments from the commits being merged. This indicates what portion of code deletions in the branch were ultimately accepted as part of the merge.

### G. Main Branch Code Longevity Report

For code in the main branch, it may be helpful to look at other aspects of how long that code survives over time, which is referred to as code longevity. The previous report classifies effort in a binary manner based on whether or not it was merged into the main branch. For code in the main branch, which is long-running rather than temporary, it can be useful to know how long code survived-known as code longevity-rather than just if it still remains.

Code longevity can be computed using the records generated in the main branch code survival intermediate analysis step. Due to the two-dimensional nature of this data-having both a lifetime duration and a time that code was created or another attribute like the author-one method that can be helpful is cohort analysis.

In cohort analysis, the output records contain the attributes used for grouping data together, such as author, date created, file name, etc., but there are multiple values, one for each time bucket. For example, cohort analysis output records may have the date code was written as well as an amount of code deleted within one hour, one day, one month, one year, and remaining in the repository. This facilitates fair comparison between code of different ages to see what portion survived for a similar time period. Otherwise, comparing the amount of surviving code written in the past year to the year before would not be fair because older code is inherently more likely to be deleted, and the older code could have had a lower deletion rate at the same age as the current code.

In addition to cohort analysis, it may be helpful to calculate how much code is removed in total each time period to calculate a “depletion” cost for main branch code inventory. This can provide insight into actual costs associated with software development expenses that may have been treated as a capital expense when code was originally created.

Other helpful values to compute from the code longevity cohort data include the average amount of code removed after certain time periods. This information can be used to create a more accurate depreciation schedule for capitalized software development expenses.

### H. Merge Conflict Report

Another helpful type of report is a merge conflict report. This report can take the records generated by the intermediate merge conflict detection step to produce aggregate information about the prevalence and cost of merge conflicts.

There are multiple values that may be useful to include in a merge conflict report. First, it may be helpful to compute the total percentage of merge commits that have any conflicted lines in them by counting the number of records with conflict lines greater than zero from the records generated in the earlier merge conflict analysis step. It may also be desirable to compute the ratio of conflicted lines total lines to indicate the portion of each merge commit that involves a conflict.

Additionally, a merge conflict report may aggregate raw hunk fragments from merge commits that do not have a source fragment ID to facilitate aggregation based on other attributes like file names, file types, or original authors. Using these fragments that indicate changes made in merge commits to resolve conflicts, values can be computed such as the number of distinct merge commits having conflicts, the total number of conflicted lines, or the average ratio of conflict lines divided by total lines added by fragments in merge commits having those same attributes (e.g., by author, by file type).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of producing high-level report data from low-level data extracted from a repository of one or more software objects in a software version control system which tracks changes to the one or more software objects over time, the method comprising:
Receiving sets of commit source data extracted from the repository of the one or more software objects in the software version control system, each set of commit source data including commit patches which describe how to modify the one or more software objects to arrive at a new state of the one or more software objects;
processing the commit patches to obtain hunk records and a list of any renamed, deleted or created software objects, the hunk records comprising records for individual segments of changed content in each commit patch;
processing the hunk records utilizing a commit-blame procedure to produce output records indicating history and original source of changes from the commit patches;
performing the commit-blame procedure on input commits and commit patches to produce intermediate data records for at least one of the input commits and software;
analyzing the intermediate data records to obtain information relating to whether software code is still surviving in a software code base or when the software code was removed from the software code base; and
producing at least one report by aggregating the information.

2. The method as claimed in claim 1, wherein each set of commit source data includes a list of commits and a list of refs which are names or tokens associated with particular commit identifiers.

3. The method as claimed in claim 1, wherein each set of commit source data is extracted through an application data interface (API) of the software version control system.

4. The method as claimed in claim 1, wherein the output records include at least one of hunk fragment records, hunk removal records, hunk context records and blame records.

5. The method as claimed in claim 1, wherein the step of performing includes planning an execution order of the commit-blame procedure on each set of commit source data that was extracted and needs processing.

6. The method as claimed in claim 1, wherein the step of producing includes identifying attributes associated with the software code.

7. The method as claimed in claim 6, further comprising generating a grouping of the intermediate data records into groups based on the attributes and computing aggregate values for each group to produce the high-level report data which can be used to generate reports which can be presented to a user of the reports.

8. The method as claimed in claim 1, further comprising determining how long the software code survived in the software code base.

9. The method as claimed in claim 8, further comprising determining amount of time it took to write the survived software code.

10. A system for producing high-level report data from low-level data extracted from a repository of one or more software objects in a software version control system which tracks changes to the one or more software objects over time, the system comprising:
at least one hardware processor; and
at least one storage device coupled to the at least one hardware processor for storing instructions that are operable when executed by the at least one hardware processor to cause the at least one hardware processor to perform operations comprising:
receiving sets of commit source data extracted from the repository of the one or more software objects in the software version control system, each set of commit source data including commit patches which describe how to modify the one or more software objects to arrive at a new state of the one or more software objects;
processing the commit patches to obtain hunk records and a list of any renamed, deleted or created software objects, the hunk records comprising records for individual segments of changed content in each commit patch;
processing the hunk records utilizing a commit-blame procedure to produce output records indicating history and original source of changes from the commit patches;
performing the commit-blame procedure on input commits and commit patches to produce intermediate data records for at least one of the input commits and software;
analyzing the intermediate data records to obtain information relating to whether software code is still surviving in a software code base or when the software code was removed from the software code base; and
producing at least one report by aggregating the information.

11. The system as claimed in claim 10, wherein each set of commit source data includes a list of commits and a list of refs which are names or tokens associated with particular commit identifiers.

12. The system as claimed in claim 10, wherein each set of commit source data is extracted through an application data interface (API) of the software version control system.

13. The system as claimed in claim 10, wherein the output records include at least one of hunk fragment records, hunk removal records, hunk context records and blame records.

14. The system as claimed in claim 10, wherein the operation of performing includes the operation of planning an execution order of the commit-blame procedure on each set of commit source data that was extracted and needs processing.

15. The system as claimed in claim 10, wherein the operation of producing includes the operation of identifying attributes associated with the software code.

16. The system as claimed in claim 15, further comprising the operation of generating a grouping of the intermediate data records into groups based on the attributes and the operation of computing aggregate values for each group to produce the high-level report data which can be used to generate reports which can be presented to a user of the reports.

17. The system as claimed in claim 10, further comprising the operation of determining how long the software code survived in the software code base.

18. The system as claimed in claim 17, further comprising the operation of determining amount of time it took to write the survived software code.

19. A computer readable storage medium storing a program of instructions executable by a machine to perform operations, the operations comprising:
receiving sets of commit source data extracted from a repository of the one or more software objects in a software version control system, each set of commit source data including commit patches which describe how to modify the one or more software objects to arrive at a new state of the one or more software objects;
processing the commit patches to obtain hunk records and a list of any renamed, deleted or created software objects, the hunk records comprising records for individual segments of changed content in each commit patch;
processing the hunk records utilizing a commit-blame procedure to produce output records indicating history and original source of changes from the commit patches;
performing the commit-blame procedure on input commits and commit patches to produce intermediate data records for at least one of the input commits and software;
analyzing the intermediate data records to obtain information relating to whether software code is still surviving in a software code base or when the software code was removed from the software code base; and
producing at least one report by aggregating the information.
